(19) United States
(12) Patent Application Publication
(10) Pub. No.: US 2018/0228238 A1
(43) Pub. Date: Aug. 16, 2018

(54) HELMET WITH BUILT-IN AUTOMOBILE DATA RECORDER

(71) Applicant: CAIO GANSAUSKAS, Sao Paulo/SP (BR)

(72) Inventor: CAIO GANSAUSKAS, Sao Paulo/SP (BR)

(21) Appl. No.: 15/431,815

(22) Filed: Feb. 14, 2017

(51) Int. Cl. A42B 3/04; G02B 23/12; G02B 27/01

(52) U.S. Cl. CPC A42B 3/042; A42B 3/0433; G02B 2027/0138; G02B 27/0172; A42B 3/04; G02B 23/125

(57) ABSTRACT

A helmet with a built-in automobile data recorder is provided, including a helmet shell, with a motherboard and a deputy motherboard thereon, a flat cable is connected there between. The motherboard has a lens and a flat cable joint, and the deputy motherboard has a lithium battery, a charging data interface, a function key, and a working lamp, a reset key and an abnormal lamp being arranged from top to bottom. A sealing cover where the motherboard is fixed by screws is arranged on top of the helmet shell, the lens is mounted on top of the helmet shell, and the deputy motherboard is mounted on a side of the helmet shell. The embodiments have the following advantages: 1. reasonable structure and built-in automobile data recorder, 2. powerful functions and high stability, 3. no installation and convenient use, 4. direct connection with a portable power source.

### FIELD OF TECHNOLOGY

The following relates to a novel helmet, and in particular to a helmet with a built-in automobile data recorder, which is mainly used in the field of protection of a driver in motor vehicles and sport events, etc.

### BACKGROUND

An automobile data recorder can be regarded as a “black box” during road driving. It is mounted on a vehicle or a helmet to shoot and record images and sounds on the driving path of the vehicle by a high-definition camera. When an accident happens, evidence is provided immediately to protect the rights of a driver. The automobile data recorders available on the market now are sold separately and are mounted on the helmets for use if necessary, thereby belonging to an external type. Although they are convenient for storage, for long-term outdoor use, electronic components are easy to age, which is not conducive to the service lives of automobile data recorders, and connections between parts are easy to damage during assembly for use. The current built-in automobile data recorders of the helmet are few and are basically attached to the outside of the helmets, therefore when the helmets are used, equipment vibrations or poor circuit contact will be caused by wind resistance, which greatly affects the use effect.

In view of the defects of the above products, in order to meet various needs of customers, provide a built-in automobile data recorder and ensure high equipment stability and convenient use, a new product is urgently needed.

### SUMMARY

An aspect relates to a helmet with a built-in automobile data recorder. The following has the advantages that the structure is reasonable, the automobile data recorder is built-in, the equipment stability is high, the use is convenient, etc.

To solve the aforementioned technical problem, embodiments of the invention provide a helmet with a built-in automobile data recorder, which mainly includes a helmet shell, wherein a motherboard and a deputy motherboard are mounted on the helmet shell, a flat cable is connected between the motherboard and the deputy motherboard, a lens is arranged on the motherboard, a lithium battery and a charging data interface are arranged on the deputy motherboard, a sealing cover is arranged at the top of the helmet shell, a flat cable joint is arranged on the motherboard, a function key is arranged on the deputy motherboard, a working lamp, a reset key and an abnormal lamp are respectively arranged on the deputy motherboard from top to bottom, the motherboard is fixed on the sealing cover by screws, the lens is mounted on the top of the helmet shell, and the deputy motherboard is mounted on a side of the helmet shell.

The design principle of the helmet with the built-in automobile data recorder in embodiments of the invention are as follows: the helmet and the automobile data recorder are an entirety, which is divided into a motherboard and a deputy motherboard, the motherboard is placed at the midpoint of an inner shell at the top of the helmet and is provided with a high-definition lens and a circuit board storage element device, and the deputy motherboard is placed on the side face of the helmet and is provided with a battery, a control device and a charging device; the motherboard and the deputy motherboard are connected by the flat cable, the recorder of the utility model is only controlled by one key, the on/off function is achieved after the key is long pressed, the pause/continue function is achieved after the key is pressed for a short time, and the startup state is determined by a flicking state of an indicator lamp on the motherboard. The motherboard is provided with a storage card for storing data and can output files in AVI and JPEG formats. When the data storage is full, the first stored data will be automatically deleted, and a data line can also be connected to a computer to copy the data for check. Embodiments of the invention can achieve high-speed dolly shot and can completely record a video even in a violent jitter situation. Furthermore, embodiments of the invention can be charged without being detached. When the electric quantity is insufficient, a charging port hidden in the helmet is found, and a charging line is inserted to charge it.

The helmet with the built-in automobile data recorder in embodiments of the invention have the following main advantages:
1. The structure is reasonable, and the automobile data recorder is built-in.
2. The function is powerful, and the stability is high.
3. It does not need to be mounted, thereby being convenient to use.
4. The utility model can be directly connected to a portable power source.

### BRIEF DESCRIPTION

Some of the embodiments will be described in detail, with reference to the following figures, wherein like designations denote like members, wherein:

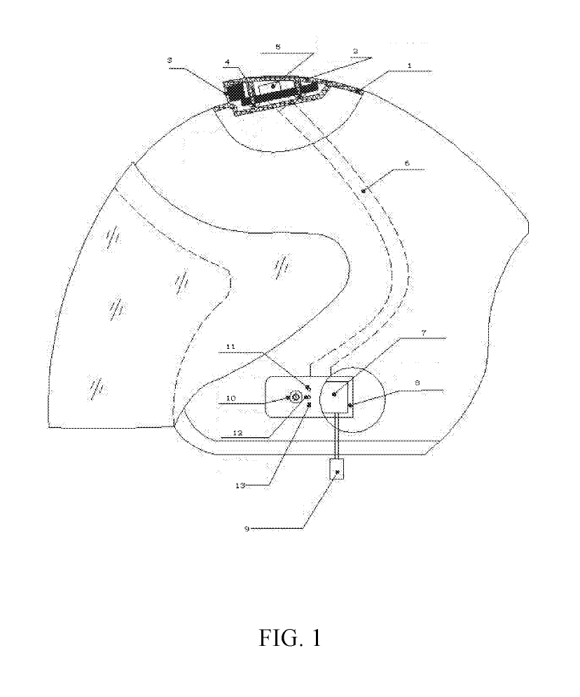

FIG. 1 is a schematic diagram of an overall structure of a helmet with a built-in automobile data recorder in embodiments of the invention.

Illustration to reference signs: 1. helmet shell 2. sealing cover 3. lens 4. motherboard 5. flat cable joint 6. flat cable 7. deputy motherboard 8. lithium battery 9. charging data port 10. function key 11. working lamp 12. reset key 13. abnormal lamp

### DETAILED DESCRIPTION

The following will be further illustrated below in detail in conjunction with the accompanying drawings and specific embodiments.

To understand embodiments of the invention more easily, the implementation of embodiments of the invention will be illustrated below in detail by specific embodiments.

As shown in FIG. 1, a helmet with a built-in automobile data recorder in embodiments of the invention mainly includes a helmet shell 1, wherein a motherboard 4 and a deputy motherboard 7 are mounted on the helmet shell 1, a flat cable 6 is connected between the motherboard 4 and the deputy motherboard, a lens 3 is arranged on the motherboard, a lithium battery 8 and a charging data interface 9 are arranged on the deputy motherboard 7, a sealing cover 2 is arranged on the top of the helmet shell 1, a flat cable joint 5 is arranged on the motherboard 4, a function key 10 is arranged on the deputy motherboard 7, a working lamp 11, a reset key 12 and an abnormal lamp 13 are respectively arranged on the deputy motherboard 7 from top to bottom, the motherboard 4 is fixed on the sealing cover 2 by screws, the lens 3 is mounted on the top of the helmet shell 1, and the deputy motherboard 7 is mounted on a side of the helmet shell 1.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A helmet with a built-in automobile data recorder, comprising a helmet shell, wherein a motherboard and a deputy motherboard are mounted on the helmet shell, a flat cable connected between the motherboard and the deputy motherboard, a lens arranged on the motherboard, and a lithium battery and a charging data interface arranged on the deputy motherboard.

2. The helmet with the built-in automobile data recorder of claim 1, wherein a sealing cover is arranged on the top of the helmet shell.

3. The helmet with the built-in automobile data recorder of claim 1, wherein a flat cable joint is arranged on the motherboard.

4. The helmet with the built-in automobile data recorder of claim 1, wherein a function key is arranged on the deputy motherboard.

5. The helmet with the built-in automobile data recorder of claim 1, wherein a working lamp, a reset key and an abnormal lamp are respectively arranged on the deputy motherboard from top to bottom.

6. The helmet with the built-in automobile data recorder of claim 1, wherein the motherboard is fixed on the sealing cover by screws.

7. The helmet with the built-in automobile data recorder of claim 1, wherein the lens is mounted on the top of the helmet shell.

8. The helmet with the built-in automobile data recorder of claim 1, wherein the deputy motherboard is mounted on a side of the helmet shell.
